(19) United States
(12) Patent Application Publication
(10) Pub. No.: US 2024/0381363 A1
(43) Pub. Date: Nov. 14, 2024

(54) UPLINK REPETITION TRANSMISSIONS

(71) Applicant: QUALCOMM Incorporated, San Diego, CA (US)

(72) Inventors: Ahmed ELSHAFIE, San Diego, CA (US); Muhammad Sayed Khairy ABDELGHAFFAR, San Jose, CA (US); Alexandros MANOLAKOS, Athens (GR); Gokul SRIDHARAN, Sunnyvale, CA (US)

(21) Appl. No.: 18/683,594

(22) PCT Filed: Oct. 13, 2022
(86) PCT No.: PCT/US2022/078069

§ 371 Date: Feb. 14, 2024

(30) Foreign Application Priority Data
Oct. 18, 2021 (GR) 20210100712

(51) Int. Cl. H04W 72/21; H04W 72/0446; H04W 72/1268; H04W 72/231

(52) U.S. Cl. CPC H04W 72/21; H04W 72/0446; H04W 72/1268; H04W 72/231

(57) ABSTRACT

Various aspects of the present disclosure generally relate to wireless communication. In some aspects, a user equipment (UE) may receive a repetition configuration associated with transmitting a plurality of repetitions of an uplink transmission, the repetition configuration including at least one of: offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The UE may transmit at least one repetition of the uplink transmission based at least in part on the repetition configuration. Numerous other aspects are described.

### CROSS-REFERENCE TO RELATED APPLICATION

This Patent Application claims priority to Greece Patent Application No. 20210100712, filed on Oct. 18, 2021, entitled “UPLINK REPETITION TRANSMISSIONS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for uplink repetition transmissions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a UE. The method may include receiving a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The method may include transmitting at least one repetition of the uplink transmission based at least in part on the repetition configuration.

Some aspects described herein relate to a method of wireless communication performed by a base station. The method may include transmitting a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The method may include receiving at least one repetition of the uplink transmission based at least in part on the repetition configuration.

Some aspects described herein relate to a UE for wireless communication. The user equipment may include a memory, a transceiver, and one or more processors coupled to the transceiver and the memory. The one or more processors may be configured to receive, via the transceiver, a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The one or more processors may be configured to transmit, via the transceiver, at least one repetition of the uplink transmission based at least in part on the repetition configuration.

Some aspects described herein relate to a base station for wireless communication. The base station may include a memory, a transceiver, and one or more processors coupled to the transceiver and the memory. The one or more processors may be configured to transmit, via the transceiver, a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The one or more processors may be configured to receive, via the transceiver, at least one repetition of the uplink transmission based at least in part on the repetition configuration.

Some aspects described herein relate to a non-transitory computer-readable medium that stores a set of instructions for wireless communication by a UE. The set of instructions, when executed by one or more processors of the UE, may cause the UE to receive a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The set of instructions, when executed by one or more processors of the UE, may cause the UE to transmit at least one repetition of the uplink transmission based at least in part on the repetition configuration.

Some aspects described herein relate to a non-transitory computer-readable medium that stores a set of instructions for wireless communication by a base station. The set of instructions, when executed by one or more processors of the base station, may cause the base station to transmit a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The set of instructions, when executed by one or more processors of the base station, may cause the base station to receive at least one repetition of the uplink transmission based at least in part on the repetition configuration.

Some aspects described herein relate to an apparatus for wireless communication. The apparatus may include means for receiving a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The apparatus may include means for transmitting at least one repetition of the uplink transmission based at least in part on the repetition configuration.

Some aspects described herein relate to an apparatus for wireless communication. The apparatus may include means for transmitting a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The apparatus may include means for receiving at least one repetition of the uplink transmission based at least in part on the repetition configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of uplink repetition type A and uplink repetition type B, in accordance with the present disclosure.

FIGS. 4A-4E are diagrams illustrating examples associated with uplink repetition transmissions, in accordance with the present disclosure.

FIGS. 5 and 6 are diagrams illustrating example processes associated with uplink transmission repetitions, in accordance with the present disclosure.

FIGS. 7 and 8 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

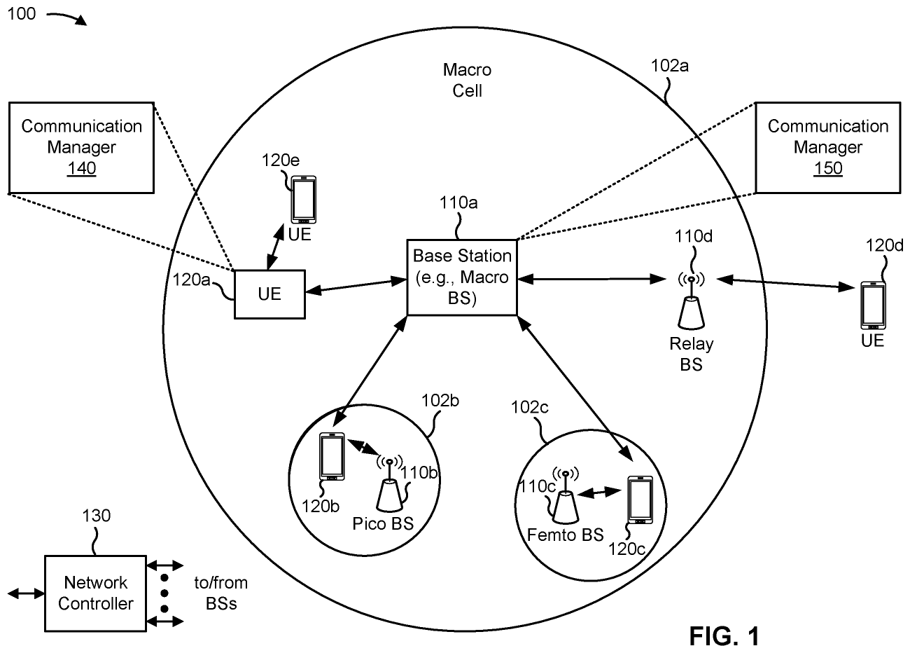

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a repetition configuration associated with transmitting a plurality of repetitions of an uplink transmission, the repetition configuration including at least one of offset information indicating an offset between a first repetition of the plurality of repetitions and a second repetition of the plurality of repetitions, start symbol information indicating a starting symbol of the first repetition and a starting symbol of the second repetition, or size information indicating a size of the first repetition and a size of the second repetition; and transmit at least one repetition of the uplink transmission based at least in part on the repetition configuration. Additionally, or alternatively, the communication manager 140 may perform one or more other operations described herein.

In some aspects, the base station 110 may include a communication manager 150. As described in more detail elsewhere herein, the communication manager 150 may transmit a repetition configuration associated with transmitting a plurality of repetitions of an uplink transmission, the repetition configuration including at least one of offset information indicating an offset between a first repetition of the plurality of repetitions and a second repetition of the plurality of repetitions, start symbol information indicating a starting symbol of the first repetition and a starting symbol of the second repetition, or size information indicating a size of the first repetition and a size of the second repetition; and receive at least one repetition of the uplink transmission based at least in part on the repetition configuration. Additionally, or alternatively, the communication manager 150 may perform one or more other operations described herein.

As indicated above, FIG. 1 is provided as an example. Other examples may differ from what is described with regard to FIG. 1.

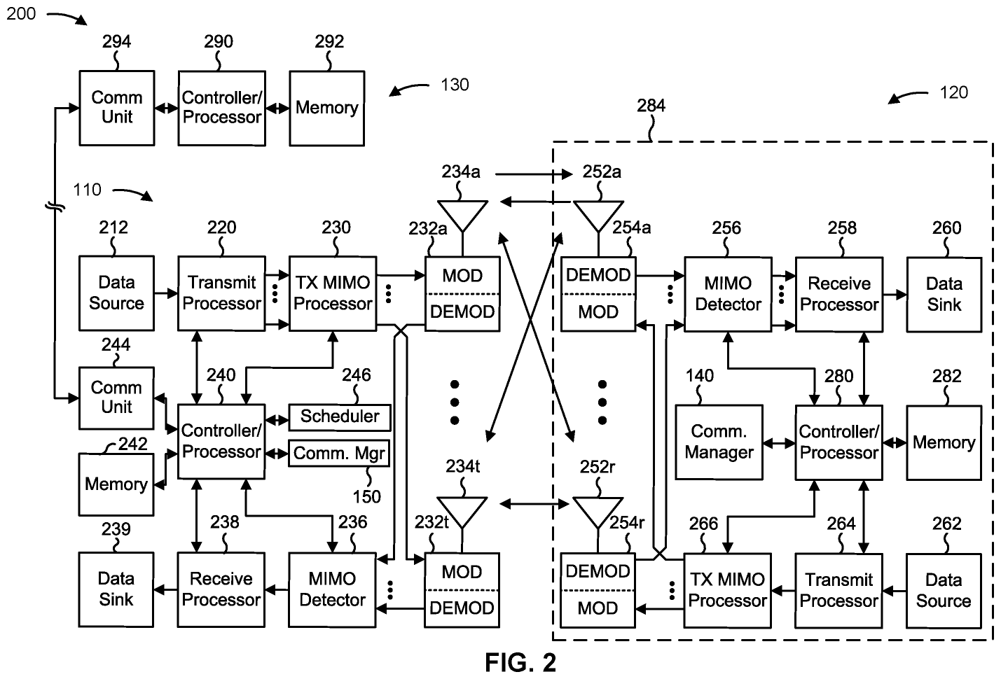

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

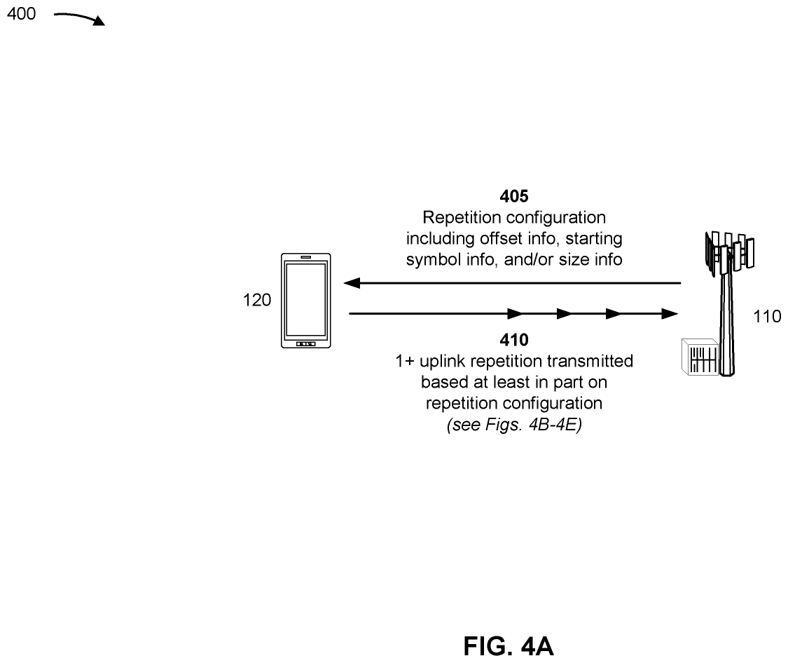

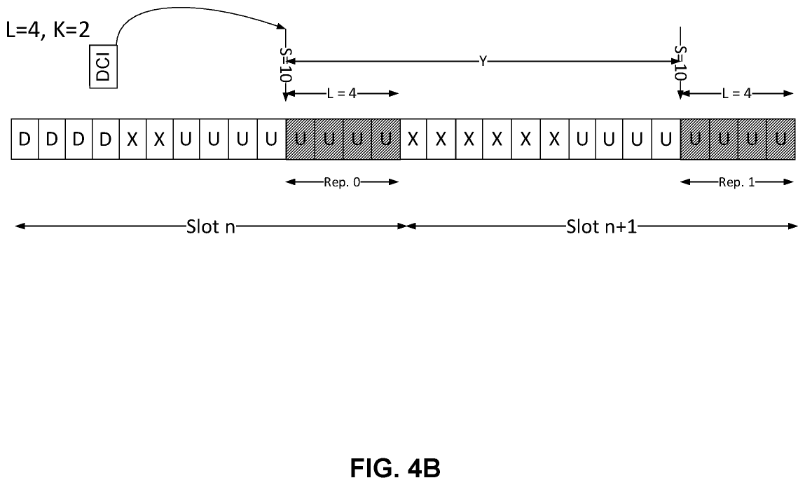

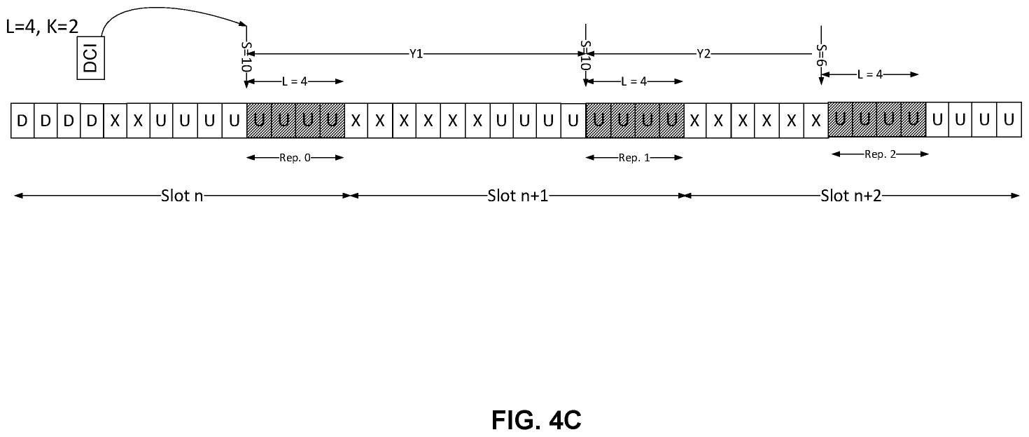

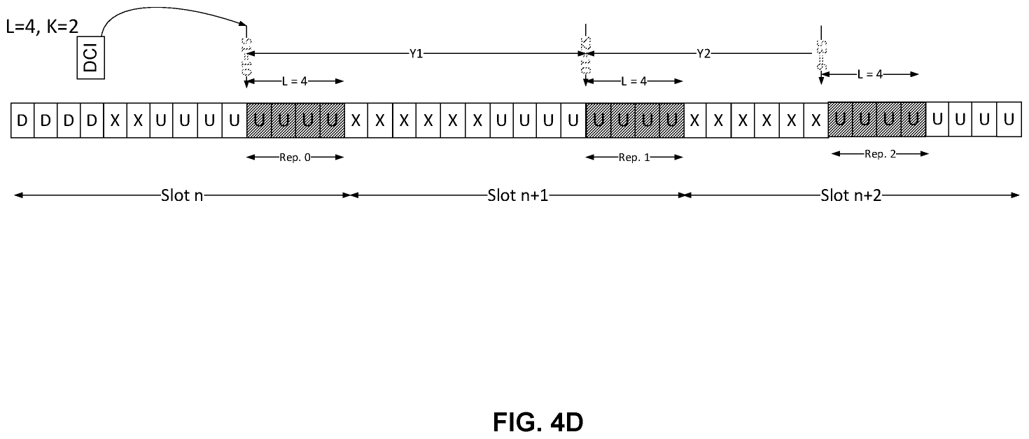

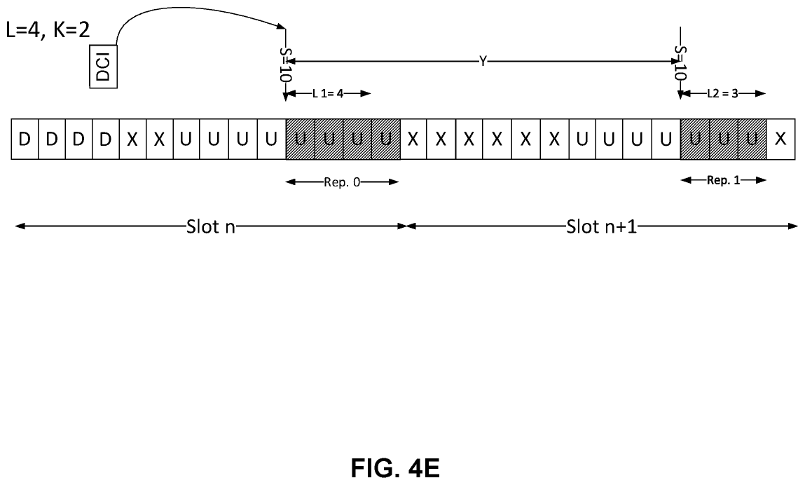

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-8).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-8).

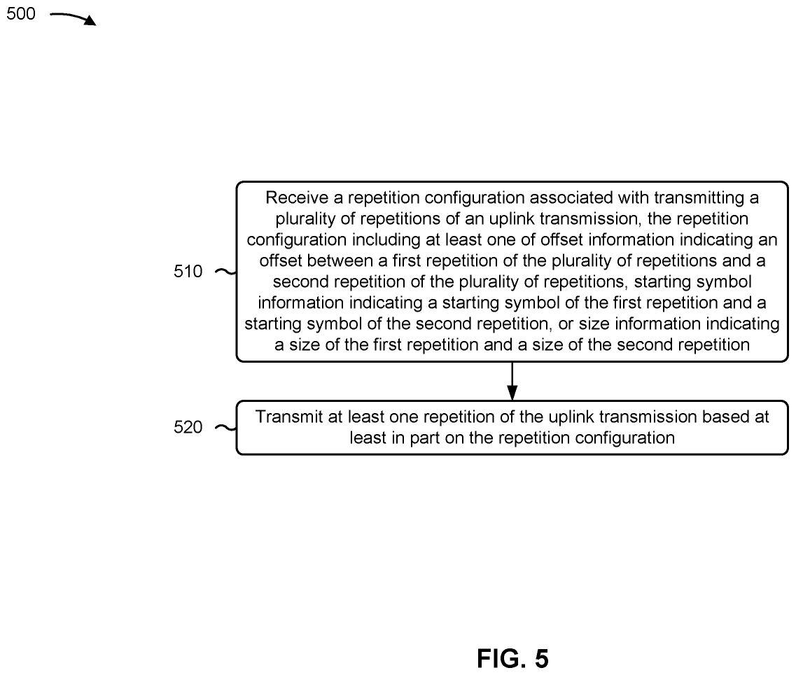

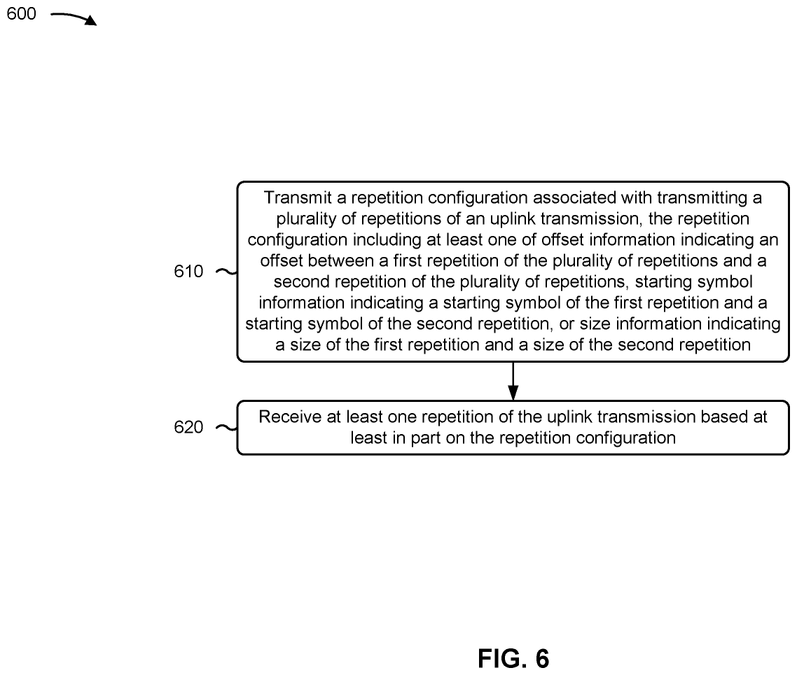

The controller/processor 240 of the base station 110, the controller/processor 280 of the UE 120, and/or any other component(s) of FIG. 2 may perform one or more techniques associated with uplink repetition transmissions, as described in more detail elsewhere herein. For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE includes means for receiving a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition (e.g., using antenna 252, modem 254, MIMO detector 256, receive processor 258, controller/processor 280, memory 282, or the like); and/or means for transmitting at least one repetition of the uplink transmission based at least in part on the repetition configuration (e.g., using controller/processor 280, transmit processor 264, TX MIMO processor 266, modem 254, antenna 252, memory 282, or the like). The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition (e.g., using controller/processor 240, transmit processor 220, TX MIMO processor 230, modem 232, antenna 234, memory 242, or the like); and/or means for receiving at least one repetition of the uplink transmission based at least in part on the repetition configuration (e.g., using antenna 234, modem 232, MIMO detector 236, receive processor 238, controller/processor 240, memory 242, or the like). The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

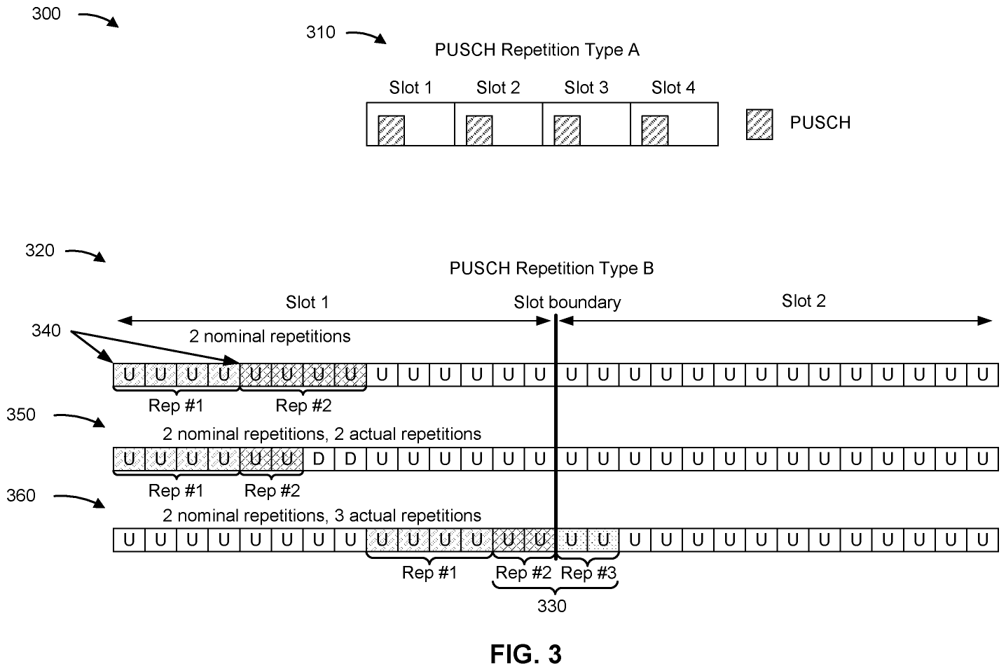

FIG. 3 is a diagram illustrating an example 300 of uplink repetition type A and uplink repetition type B, in accordance with the present disclosure. In some aspects, the techniques described herein may be applied in connection with repetitions of an uplink data transmission(e.g., a physical uplink shared channel (PUSCH) transmission), repetitions of an uplink control transmission (e.g., a physical uplink control channel (PUCCH) transmission), or repetitions of another type of uplink communication.

A repetition, such as an uplink repetition or a downlink repetition, may be used to improve reliability, such as for ultra-reliable low-latency communication (URLLC) or for UEs 120 located in a geographic area with poor channel conditions (e.g., a cell edge). When repetitions are used, a transmitter repeats transmission of a communication multiple times. For example, a UE 120 may transmit an initial uplink communication and may repeat transmission of (e.g., may retransmit) that uplink communication one or more times. When a UE 120 is configured with repetitions, the UE 120 may retransmit an initial transmission without first receiving feedback (e.g., an acknowledgement (ACK) or negative acknowledgement (NACK)) indicating whether the initial transmission was successfully received. In some aspects, ACK or NACK feedback may be disabled for repetitions, thereby reducing signaling overhead that would otherwise be used for ACK or NACK feedback.

In some aspects, a repeated transmission (sometimes referred to as a retransmission) may include the exact same encoded bits (e.g., information bits and parity bits) as the initial transmission and/or as another repeated transmission (e.g., where a same redundancy version is used across repetitions). Alternatively, a repeated transmission may include different encoded bits (e.g., a different combination of information bits and/or parity bits) than the initial transmission and/or another repeated transmission (e.g., where different redundancy versions are used across repetitions).

As used herein, the term “repetition” is used to refer to the initial communication and is also used to refer to a repeated transmission of the initial communication. For example, if the UE 120 is configured to transmit four repetitions, then the UE 120 may transmit an initial transmission and may transmit three repeated transmissions of that initial transmission. Thus, each transmission (regardless of whether the transmission is an initial transmission or a retransmission) is counted as a repetition. A repetition may be transmitted in a transmission occasion, which is sometimes referred to as a transmission instance.

As shown by reference number 310, for a first uplink repetition type referred to as uplink repetition type A, uplink transmission occasions are not permitted to cross a slot boundary, and only one uplink transmission occasion is permitted per slot. Thus, if a UE 120 is configured with uplink repetition type A, then the UE 120 cannot transmit a repetition in a set of symbols that occurs in more than one slot, and can only transmit the repetition if all symbols of the repetition occur in the same slot. Furthermore, if a UE 120 is configured with uplink repetition type A, then the UE 120 cannot transmit more than one repetition per slot. Thus, for uplink repetition type A, a transmission occasion corresponds to a slot. Furthermore, for uplink repetition type A, the time domain allocation for a repetition within a slot may be the same across all slots for which repetitions are scheduled. In other words, each repetition, associated with the same initial transmission, may start in the same starting symbol (e.g., having the same starting symbol index) in each slot in which a repetition is scheduled and may occupy the same number of symbols. Notably, as indicated above, uplink repetition type A has fixed timing between uplink repetitions (e.g., 14 symbols between uplink repetition). This fixed timing increases delay associated with transmitting uplink repetitions, which is undesirable for some types of communications, such as URLLC communications.

As shown by reference number 320, for a second uplink repetition type referred to as uplink repetition type B, uplink transmission occasions are permitted to cross a slot boundary (as shown by reference number 330, where a single nominal repetition crosses a slot boundary and is divided into two actual repetitions), and more than one uplink transmission occasion is permitted per slot (as shown by reference number 340). Thus, if a UE 120 is configured with uplink repetition type B, then the UE 120 can transmit a repetition (e.g., a nominal repetition) in a set of symbols that occurs in more than one slot, and the UE 120 can transmit the repetition even if all symbols of the repetition do not occur in the same slot. Furthermore, if a UE 120 is configured with uplink repetition type B, then the UE 120 can transmit more than one repetition per slot. Thus, for uplink repetition type B, a transmission occasion corresponds to a portion of a slot, such as a mini-slot. Furthermore, for uplink repetition type B, the time domain allocation for a repetition within a slot may be different for different repetitions. In other words, different repetitions, associated with the same initial transmission, may start in different starting symbols (e.g., having different starting symbol indexes).

In uplink repetition type B, the term “nominal repetition” refers to a potential uplink repetition as indicated by the base station 110. A nominal repetition signaled or scheduled by the base station 110 may be truncated or divided into one or two “actual repetitions.” A nominal repetition consists of a set of consecutive symbols over which the UE 120 is expected to transmit an uplink repetition. However, when this set of consecutive symbols crosses a slot boundary, contains semi-static downlink symbols, or encounters (e.g., is scheduled to occur within) an invalid symbol pattern, among other examples, then the UE 120 is required to split the nominal repetition into one or two parts. Each of these parts is then referred to as an “actual repetition.”

For example, as shown by reference number 350, an uplink transmission may include four symbols, and a base station 110 may configure a UE 120 (e.g., in a radio resource control (RRC) message) to transmit two nominal repetitions of the uplink transmission. The two nominal repetitions may span a total of eight symbols and may each include four symbols. The two nominal repetitions are scheduled in the first eight symbols of a slot (shown as Slot 1). For example, the first nominal repetition may be scheduled in the first four symbols of a slot (the first, second, third, and fourth symbols), and the second nominal repetition may be scheduled in the next four symbols of the slot (the fifth, sixth, seventh, and eighth symbols). The first nominal repetition is actually transmitted in the first four symbols and is thus treated as a single actual repetition (shown as “Rep #1” with respect to reference number 350). For the second nominal repetition, the UE 120 actually transmits the first two symbols but cannot transmit the last two symbols because the last two symbols are downlink symbols. Thus, the UE 120 drops the last two symbols, and the resulting actual repetition (shown as “Rep #2” with respect to reference number 350) includes only the first two symbols.

As another example, as shown by reference number 360, an uplink transmission may include four symbols, and a base station 110 may configure a UE 120 to transmit two nominal repetitions of the uplink transmission. The two nominal repetitions may each include four symbols, shown as the ninth, tenth, eleventh, and twelfth symbols of a first slot (Slot 1) for a first nominal repetition, and shown as the thirteenth and fourteenth symbols of the first slot plus the first and second symbols of a second slot (Slot 2) for a second nominal repetition. The first nominal repetition is transmitted in four consecutive symbols and is thus treated as a single actual repetition (shown as “Rep #1” with respect to reference number 360). The second nominal repetition is transmitted in consecutive symbols that cross a slot boundary (e.g., that occur in more than one slot) and is thus divided into two actual repetitions, with a first actual repetition (shown as “Rep #2” with respect to reference number 360) being transmitted in a first set of consecutive symbols in the first slot (the thirteenth and fourteenth symbols of Slot 1) and a second actual repetition (shown as “Rep #3) being transmitted in a second set of consecutive symbols in the second slot (the first and second symbols of Slot 2).

Notably, the use of uplink repetition type B can reduce delay that would otherwise be caused by fixed timing between uplink repetitions (as in the case of uplink repetition type A). However, as described above, a nominal repetition can be divided or broken into two or more actual repetitions (e.g., due to a collision with one or more downlink symbols, due to crossing a slot boundary, or the like). In such a scenario, some portion of a given actual repetition may be dropped (e.g., when only one symbol is left for the given actual repetition), thereby reducing reliability associated with the transmission of the uplink repetitions. Furthermore, maintaining phase coherency across actual repetitions (e.g., when a nominal repetition crosses a slot boundary such that two actual repetitions are transmitted in different slots) may be difficult or impossible, which furthers reduces reliability.

As indicated above, FIG. 3 is provided as an example. Other examples may differ from what is described with respect to FIG. 3.

Some techniques and apparatuses described herein provide improved uplink repetition transmissions. More specifically, the techniques and apparatuses described herein provide a generalized framework for uplink repetition transmissions which can resolve issues associated with uplink repetition type A (e.g., delay caused by fixed uplink repetition timing) and issues associated with uplink repetition type B (e.g., decreased reliability of actual repetitions), while increasing flexibility for transmitting uplink repetitions.

For example, in some aspects, a base station may transmit, and a UE may receive, a repetition configuration associated with transmitting a plurality of repetitions of an uplink transmission. In some aspects, the repetition configuration may include offset information indicating an offset between a first repetition of the plurality of repetitions and a second repetition of the plurality of repetitions. Additionally, or alternatively, the repetition configuration may include starting symbol information indicating a starting symbol of the first repetition and a starting symbol of the second repetition. Additionally, or alternatively, the repetition configuration may include size information indicating a size of the first repetition and a size of the second repetition. The UE may transmit, and the base station may receive, at least one repetition of the uplink transmission based at least in part on the repetition configuration. Additional details are provided below.

FIGS. 4A-4E are examples associated with uplink repetition transmissions, in accordance with the present disclosure. As shown in FIG. 4A, a base station 110 and a UE 120 may communicate with one another. In some aspects, the base station 110 and the UE 120 may be included in a wireless network, such as a wireless network 100. The base station 110 and the UE 120 may communicate via a wireless access link, which may include an uplink and a downlink.

As shown in FIG. 4A by reference 405, the base station 110 may transmit, and the UE 120 may receive, a repetition configuration associated with transmitting a plurality of repetitions of an uplink transmission. The repetition configuration includes a configuration based at least in part on which the UE 120 is to transmit repetitions of an uplink transmission.

In some aspects, the repetition configuration may include offset information. In some aspects, the offset information indicates an offset between a first repetition of the plurality of repetitions and a second (e.g., subsequent) repetition of the plurality of repetitions. In some aspects, the offset information indicates a fixed offset associated with the plurality of repetitions. That is, in some aspects, the offset information may indicate a single offset value to be used as an offset between an initial transmission and a first retransmission, between the first retransmission and a second retransmission, and so on. In some aspects, the fixed offset may be indicated in terms of symbols, in terms of sub-slots, or in terms of slots. FIG. 4B is a diagram illustrating an example of a fixed offset Y. In the example shown in FIG. 4B, the plurality of repetitions includes two repetitions (K=2) and each repetition has a length of four symbols (e.g., L=4). In this example, the fixed offset Y is 14 symbols (e.g., Y=14). Notably, if the offset information indicates a fixed offset Y of 14 symbols, then the repetition configuration would cause the uplink repetitions to be transmitted in a similar manner to that of uplink repetition type A. Similarly, if the offset information indicates a fixed offset Y that matches the length of the uplink repetitions (e.g., 4 symbols in FIG. 4B), then the repetition configuration would cause the uplink repetitions to be transmitted in a similar manner to that of uplink repetition type B. Of course, the fixed offset can be another value, meaning that the fixed offset can be selected so as to reduce delay (as compared to uplink repetition type A) and/or improve reliability (as compared to uplink repetition type B).

In some aspects, the offset information indicates a sequence of offsets, where each offset in the sequence of offsets is associated with a different pair of repetitions from the plurality of repetitions. For example, in some aspects, the offset information may indicate a first offset value to be used as an offset between an initial transmission and a first retransmission, a second (e.g., different) offset value to be used as an offset between the first retransmission and a second retransmission, and so on. In some aspects, the sequence of offsets may be indicated in terms of symbols, in terms of sub-slots, or in terms of slots. FIG. 4C is a diagram illustrating an example of a sequence of offsets including an offset Y1 and an offset Y2. In the example shown in FIG. 4C, the plurality of repetitions includes three repetitions (K=3) and each repetition has a length of four symbols (e.g., L=4). In this example, the offset Y1 between a first repetition and a second repetition is 14 symbols (e.g., Y1=14) and the offset Y2 between the second repetition and a third repetition is 10 symbols (e.g., Y2=10). In some aspects, the sequence of offsets can be selected so as to reduce delay (as compared to uplink repetition type A) and/or improve reliability (as compared to uplink repetition type B).

In some aspects, the repetition configuration may include starting symbol information. In some aspects, the starting symbol information may indicate a starting symbol of one or more repetitions of the plurality of repetitions. In some aspects, the starting symbol information indicates a sequence of starting symbols, where each starting symbol in the sequence of starting symbols is associated with a different repetition from the plurality of repetitions. In some aspects, a given starting symbol in the sequence of starting symbols is relative to a beginning of a slot containing a corresponding repetition. For example, in some aspects, the starting symbol information may indicate a starting symbol for an initial transmission in a first slot, a starting symbol for a first retransmission in a second slot, a starting symbol for a second retransmission in a third slot, and so on. Furthermore, the starting symbol can be relative to the beginning of a slot containing a corresponding repetition. Hence, as illustrated in FIG. 4C, repetition 0 corresponds to starting symbol 10 relative to the beginning of slot n, repetition 1 corresponds to starting symbol 10 relative to beginning of slot n+1, and repetition 2 corresponds to starting symbol 6 relative to beginning of slot n+2. In some aspects, the sequence of starting symbols may be indicated in terms of symbols, in terms of sub-slots (e.g., where a given sub-slot corresponds to X symbols (0<X<13)), or in terms of slots (e.g., where a given slot corresponds to 14 symbols). FIG. 4D is a diagram illustrating an example of a sequence of starting symbols including a starting symbol S1, a starting symbol S2, and a starting symbol S3. In the example shown in FIG. 4D, the plurality of repetitions includes three repetitions (K=3) and each repetition has a length of four symbols (e.g., L=4). In this example, the starting symbol S1 of a first repetition is symbol 10 of slot n (e.g., S1=10), the starting symbol S2 of a second repetition is symbol 10 of slot n+1 (e.g., S2=10), and the starting symbol S3 of a third repetition is symbol 6 of slot n+2. In some aspects, the sequence of starting symbols can be selected so as to reduce delay (as compared to uplink repetition type A) and/or improve reliability (as compared to uplink repetition type B).

In some aspects, the repetition configuration may include size information. In some aspects, the size information may indicate a size of one or more repetitions of the plurality of repetitions. In some aspects, the size information indicates a sequence of sizes, where each size in the sequence of sizes is associated with a different repetition from the plurality of repetitions. For example, in some aspects, the size information may indicate a size for an initial transmission, a size for a first retransmission, a size for a second retransmission, and so on. In some aspects, the sequence of sizes may be indicated in terms of symbols, in terms of sub-slots, or in terms of slots. FIG. 4E is a diagram illustrating an example of a sequence of sizes including a size L1 and a size L2. In the example shown in FIG. 4E, the plurality of repetitions includes two repetitions (K=2). In this example, the size L1 of a first repetition is four symbols (e.g., L1=4) and the size S2 of a second repetition is three symbols (e.g., L2=3). In some aspects, the sequence of sizes can be selected so as to reduce delay (as compared to uplink repetition type A) and/or improve reliability (as compared to uplink repetition type B).

In some aspects, the base station 110 may transmit, and the UE 120 may receive, the repetition configuration via radio resource control (RRC) signaling. Additionally, or alternatively, the base station 110 may transmit, and the UE 120 may receive, the repetition configuration in a medium access control (MAC) control element.

Additionally, or alternatively, the base station 110 may transmit, and the UE 120 may receive, the repetition configuration in downlink control information (DCI) (e.g., in a field of a start location and indicator value (SLIV)). For example, in some aspects, a starting symbol or a size of one or more PUCCH repetitions may be (e.g., dynamically) configured in DCI using an SLIV. In some aspects, with respect to PUCCH repetitions, multiple starting symbols per resource identifier may be configured.

In some aspects, the uplink transmission may be an uplink data transmission, such as a PUSCH transmission. In some aspects, the uplink transmission may be an uplink control transmission, such as a PUCCH transmission. In some aspects, the uplink transmission may be a type of uplink transmission other than an uplink data transmission or an uplink control transmission, such as an uplink reference signal transmission.

As shown by reference 410 in FIG. 4A, the UE 120 may transmit, and the base station 110 may receive, at least one repetition of the uplink transmission based at least in part on the repetition configuration.

As indicated above, FIGS. 4A-4E are provided as examples. Other examples may differ from what is described with respect to FIGS. 4A-4E.

FIG. 5 is a diagram illustrating an example process 500 performed, for example, by a UE, in accordance with the present disclosure. Example process 500 is an example where the UE (e.g., UE 120) performs operations associated with uplink repetition transmissions.

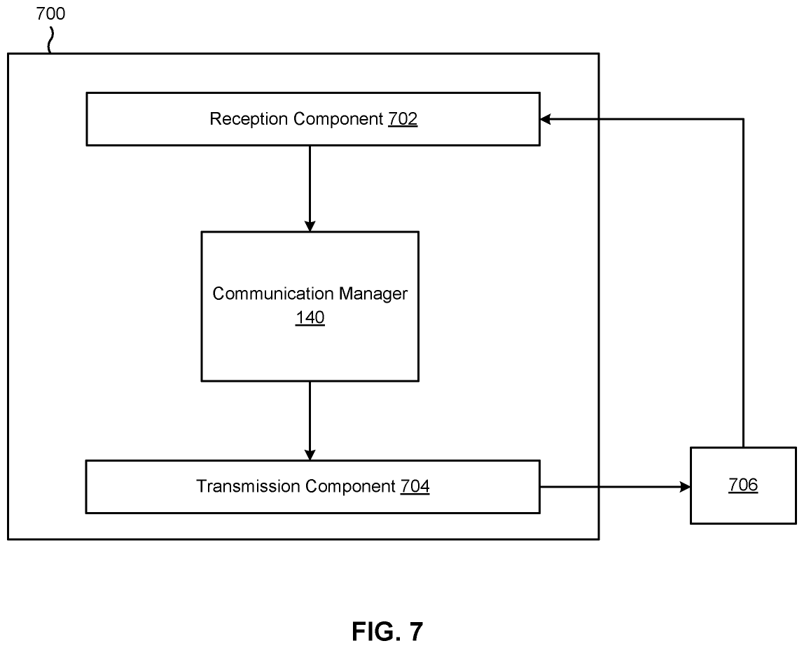

As shown in FIG. 5, in some aspects, process 500 may include receiving a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition (block 510). For example, the UE (e.g., using communication manager 140 and/or reception component 702, depicted in FIG. 7) may receive a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition, as described above, for example, with reference to FIGS. 4A-4E.

As further shown in FIG. 5, in some aspects, process 500 may include transmitting at least one repetition of the uplink transmission based at least in part on the repetition configuration (block 520). For example, the UE (e.g., using communication manager 140 and/or transmission component 704, depicted in FIG. 7) may transmit at least one repetition of the uplink transmission based at least in part on the repetition configuration, as described above, for example, with reference to FIGS. 4A-4E.

Process 500 may include additional aspects, such as any single aspect or any combination of aspects described below and/or in connection with one or more other processes described elsewhere herein.

In a first aspect, the offset information indicates a fixed offset associated with the plurality of repetitions.

In a second aspect, alone or in combination with the first aspect, the offset information indicates a sequence of offsets, each offset in the sequence of offsets being associated with a different pair of repetitions from the plurality of repetitions.

In a third aspect, alone or in combination with one or more of the first and second aspects, the offset between the first repetition and the second repetition is indicated in terms of symbols, sub-slots, or slots.

In a fourth aspect, alone or in combination with one or more of the first through third aspects, the starting symbol information indicates a sequence of starting symbols, each starting symbol in the sequence of starting symbols being associated with a different repetition of the plurality of repetitions, wherein a given starting symbol in the sequence of starting symbols is relative to a beginning of a slot containing a corresponding repetition of the plurality of repetitions.

In a fifth aspect, alone or in combination with one or more of the first through fourth aspects, the starting symbol of the first repetition or the starting symbol of the second repetition is indicated in terms of a symbol, a sub-slot, or a slot.

In a sixth aspect, alone or in combination with one or more of the first through fifth aspects, the size information indicates a sequence of sizes, each size in the sequence of sizes being associated with a different repetition from the plurality of repetitions.

In a seventh aspect, alone or in combination with one or more of the first through sixth aspects, the uplink transmission is a PUCCH transmission.

In an eighth aspect, alone or in combination with one or more of the first through seventh aspects, the uplink transmission is a PUSCH transmission.

In a ninth aspect, alone or in combination with one or more of the first through eighth aspects, the repetition configuration is received via RRC signaling.

In a tenth aspect, alone or in combination with one or more of the first through ninth aspects, the repetition configuration is received in a MAC control element.

In an eleventh aspect, alone or in combination with one or more of the first through tenth aspects, the repetition configuration is received in DCI.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with uplink repetition transmissions.

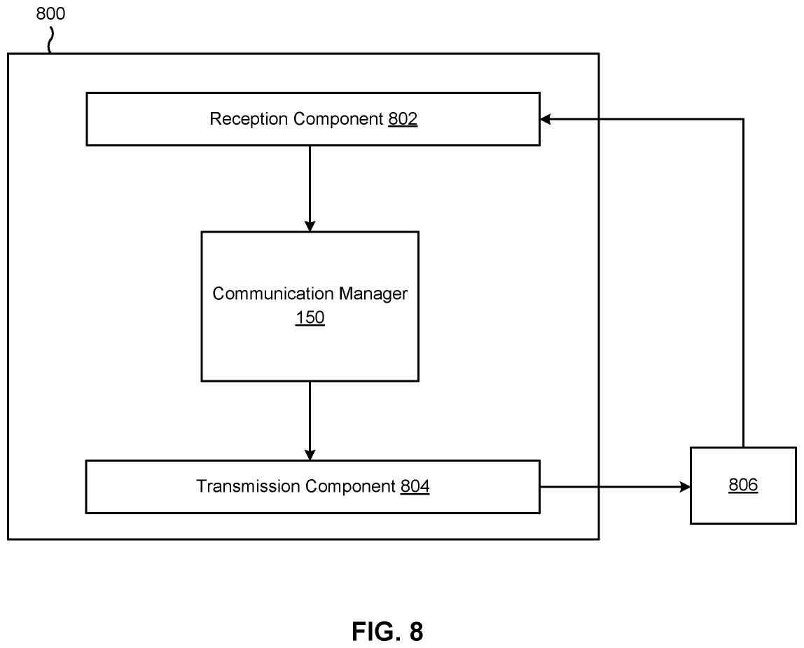

As shown in FIG. 6, in some aspects, process 600 may include transmitting a repetition configuration associated with transmitting a plurality of repetitions of an uplink transmission, the repetition configuration including at least one of: offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition (block 610). For example, the base station (e.g., using communication manager 150 and/or transmission component 804, depicted in FIG. 8) may transmit a repetition configuration associated with transmitting a plurality of repetitions of an uplink transmission, the repetition configuration including at least one of: offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition, as described above, for example, with reference to FIGS. 4A-4E.

As further shown in FIG. 6, in some aspects, process 600 may include receiving at least one repetition of the uplink transmission based at least in part on the repetition configuration (block 620). For example, the base station (e.g., using communication manager 150 and/or reception component 802, depicted in FIG. 8) may receive at least one repetition of the uplink transmission based at least in part on the repetition configuration, as described above, for example, with reference to FIGS. 4A-4E.

Process 600 may include additional aspects, such as any single aspect or any combination of aspects described below and/or in connection with one or more other processes described elsewhere herein.

In a first aspect, the offset information indicates a fixed offset associated with the plurality of repetitions.

In a second aspect, alone or in combination with the first aspect, the offset information indicates a sequence of offsets, each offset in the sequence of offsets being associated with a different pair of repetitions from the plurality of repetitions.

In a third aspect, alone or in combination with one or more of the first and second aspects, the offset between the first repetition and the second repetition is indicated in terms of symbols, sub-slots, or slots.

In a fourth aspect, alone or in combination with one or more of the first through third aspects, the starting symbol information indicates a sequence of starting symbols, each starting symbol in the sequence of starting symbols being associated with a different repetition of the plurality of repetitions, wherein a given starting symbol in the sequence of starting symbols is relative to a beginning of a slot containing a corresponding repetition of the plurality of repetitions.

In a fifth aspect, alone or in combination with one or more of the first through fourth aspects, the starting symbol of the first repetition or the starting symbol of the second repetition is indicated in terms of a symbol, a sub-slot, or a slot.

In a sixth aspect, alone or in combination with one or more of the first through fifth aspects, the size information indicates a sequence of sizes, each size in the sequence of sizes being associated with a different repetition from the plurality of repetitions.

In a seventh aspect, alone or in combination with one or more of the first through sixth aspects, the uplink transmission is a PUCCH transmission.

In an eighth aspect, alone or in combination with one or more of the first through seventh aspects, the uplink transmission is a PUSCH transmission.

In a ninth aspect, alone or in combination with one or more of the first through eighth aspects, the repetition configuration is transmitted via RRC signaling.

In a tenth aspect, alone or in combination with one or more of the first through ninth aspects, the repetition configuration is transmitted in a MAC control element.

In an eleventh aspect, alone or in combination with one or more of the first through tenth aspects, the repetition configuration is transmitted in DCI.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 140.

In some aspects, the apparatus 700 may be configured to perform one or more operations described herein in connection with FIGS. 4A-4E. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The reception component 702 may receive a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The transmission component 704 may transmit at least one repetition of the uplink transmission based at least in part on the repetition configuration.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a base station, or a base station may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 150.

In some aspects, the apparatus 800 may be configured to perform one or more operations described herein in connection with FIGS. 4A-4E. Additionally, or alternatively, the apparatus 800 may be configured to perform one or more processes described herein, such as process 600 of FIG. 6. In some aspects, the apparatus 800 and/or one or more components shown in FIG. 8 may include one or more components of the base station described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the base station described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the base station described in connection with FIG. 2. In some aspects, the transmission component 804 may be co-located with the reception component 802 in a transceiver.

The transmission component 804 may transmit a repetition configuration associated with transmitting a plurality of repetitions of an uplink transmission, the repetition configuration including at least one of offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition. The reception component 802 may receive at least one repetition of the uplink transmission based at least in part on the repetition configuration.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a UE, comprising: receiving a repetition configuration associated with transmitting a plurality of repetitions of an uplink transmission, the repetition configuration including at least one of: offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition; and transmitting at least one repetition of the uplink transmission based at least in part on the repetition configuration.

Aspect 2: The method of Aspect 1, wherein the offset information indicates a fixed offset associated with the plurality of repetitions.

Aspect 3: The method of any of Aspects 1-2, wherein the offset information indicates a sequence of offsets, each offset in the sequence of offsets being associated with a different pair of repetitions from the plurality of repetitions.

Aspect 4: The method of any of Aspects 1-3, wherein the offset between the first repetition and the second repetition is indicated in terms of symbols, sub-slots, or slots.

Aspect 5: The method of any of Aspects 1-4, wherein the starting symbol information indicates a sequence of starting symbols, each starting symbol in the sequence of starting symbols being associated with a different repetition of the plurality of repetitions, wherein a given starting symbol in the sequence of starting symbols is relative to a beginning of a slot containing a corresponding repetition of the plurality of repetitions.

Aspect 6: The method of any of Aspects 1-5, wherein the starting symbol of the first repetition or the starting symbol of the second repetition is indicated in terms of a symbol, a sub-slot, or a slot.

Aspect 7: The method of any of Aspects 1-6, wherein the size information indicates a sequence of sizes, each size in the sequence of sizes being associated with a different repetition from the plurality of repetitions.

Aspect 8: The method of any of Aspects 1-7, wherein the uplink transmission is a PUCCH transmission.

Aspect 9: The method of any of Aspects 1-7, wherein the uplink transmission is a PUSCH transmission.

Aspect 10: The method of any of Aspects 1-9, wherein the repetition configuration is received via RRC signaling.

Aspect 11: The method of any of Aspects 1-10, wherein the repetition configuration is received in a MAC control element.

Aspect 12: The method of any of Aspects 1-11, wherein the repetition configuration is received in DCI.

Aspect 13: A method of wireless communication performed by a base station, comprising: transmitting a repetition configuration associated with transmitting a plurality of repetitions of an uplink transmission, the repetition configuration including at least one of: offset information indicating an offset between a first repetition of the plurality of repetitions and a second repetition of the plurality of repetitions, starting symbol information indicating a starting symbol of the first repetition and a starting symbol of the second repetition, or size information indicating a size of the first repetition and a size of the second repetition; and receiving at least one repetition of the uplink transmission based at least in part on the repetition configuration.

Aspect 14: The method of Aspect 13, wherein the offset information indicates a fixed offset associated with the plurality of repetitions.

Aspect 15: The method of any of Aspects 13-14, wherein the offset information indicates a sequence of offsets, each offset in the sequence of offsets being associated with a different pair of repetitions from the plurality of repetitions.

Aspect 16: The method of any of Aspects 13-15, wherein the offset between the first repetition and the second repetition is indicated in terms of symbols, sub-slots, or slots.

Aspect 17: The method of any of Aspects 13-16, wherein the starting symbol information indicates a sequence of starting symbols, each starting symbol in the sequence of starting symbols being associated with a different repetition of the plurality of repetitions, wherein a given starting symbol in the sequence of starting symbols is relative to a beginning of a slot containing a corresponding repetition of the plurality of repetitions.

Aspect 18: The method of any of Aspects 13-17, wherein the starting symbol of the first repetition or the starting symbol of the second repetition is indicated in terms of a symbol, a sub-slot, or a slot.

Aspect 19: The method of any of Aspects 13-18, wherein the size information indicates a sequence of sizes, each size in the sequence of sizes being associated with a different repetition from the plurality of repetitions.

Aspect 20: The method of any of Aspects 13-19, wherein the uplink transmission is a PUCCH transmission.

Aspect 21: The method of any of Aspects 13-19, wherein the uplink transmission is a PUSCH transmission.

Aspect 22: The method of any of Aspects 13-21, wherein the repetition configuration is transmitted via RRC signaling.

Aspect 23: The method of any of Aspects 13-22, wherein the repetition configuration is transmitted in a MAC control element.

Aspect 24: The method of any of Aspects 13-23, wherein the repetition configuration is transmitted in DCI.

Aspect 25: An apparatus for wireless communication at a device, comprising a processor; memory coupled with the processor; and instructions stored in the memory and executable by the processor to cause the apparatus to perform the method of one or more of Aspects 1-12.

Aspect 26: A device for wireless communication, comprising a memory and one or more processors coupled to the memory, the one or more processors configured to perform the method of one or more of Aspects 1-12.

Aspect 27: An apparatus for wireless communication, comprising at least one means for performing the method of one or more of Aspects 1-12.

Aspect 28: A non-transitory computer-readable medium storing code for wireless communication, the code comprising instructions executable by a processor to perform the method of one or more of Aspects 1-12.

Aspect 29: A non-transitory computer-readable medium storing a set of instructions for wireless communication, the set of instructions comprising one or more instructions that, when executed by one or more processors of a device, cause the device to perform the method of one or more of Aspects 1-12.

Aspect 30: An apparatus for wireless communication at a device, comprising a processor; memory coupled with the processor; and instructions stored in the memory and executable by the processor to cause the apparatus to perform the method of one or more of Aspects 13-24.

Aspect 31: A device for wireless communication, comprising a memory and one or more processors coupled to the memory, the one or more processors configured to perform the method of one or more of Aspects 13-24.

Aspect 32: An apparatus for wireless communication, comprising at least one means for performing the method of one or more of Aspects 13-24.

Aspect 33: A non-transitory computer-readable medium storing code for wireless communication, the code comprising instructions executable by a processor to perform the method of one or more of Aspects 13-24.

Aspect 34: A non-transitory computer-readable medium storing a set of instructions for wireless communication, the set of instructions comprising one or more instructions that, when executed by one or more processors of a device, cause the device to perform the method of one or more of Aspects 13-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving a repetition configuration associated with transmitting a plurality of repetitions of an uplink transmission, the repetition configuration including at least one of:
offset information indicating an offset between a first repetition of the plurality of repetitions and a second repetition of the plurality of repetitions,
starting symbol information indicating a starting symbol of the first repetition and a starting symbol of the second repetition, or
size information indicating a size of the first repetition and a size of the second repetition; and
transmitting at least one repetition of the uplink transmission based at least in part on the repetition configuration.

2. The method of claim 1, wherein the offset information indicates a fixed offset associated with the plurality of repetitions.

3. The method of claim 1, wherein the offset information indicates a sequence of offsets, each offset in the sequence of offsets being associated with a different pair of repetitions from the plurality of repetitions.

4. The method of claim 1, wherein the offset between the first repetition and the second repetition is indicated in terms of symbols, sub-slots, or slots.

5. The method of claim 1, wherein the starting symbol information indicates a sequence of starting symbols, each starting symbol in the sequence of starting symbols being associated with a different repetition of the plurality of repetitions,
wherein a given starting symbol in the sequence of starting symbols is relative to a beginning of a slot containing a corresponding repetition of the plurality of repetitions.

6. The method of claim 1, wherein the starting symbol of the first repetition or the starting symbol of the second repetition is indicated in terms of a symbol, a sub-slot, or a slot.

7. The method of claim 1, wherein the size information indicates a sequence of sizes, each size in the sequence of sizes being associated with a different repetition from the plurality of repetitions.

8. The method of claim 1, wherein the uplink transmission is a physical uplink control channel (PUCCH) transmission or a physical uplink shared channel (PUSCH) transmission.

9. The method of claim 1, wherein the repetition configuration is received via radio resource control (RRC) signaling, in a medium access control (MAC) control element, or in downlink control information (DCI).

10. A method of wireless communication performed by a base station, comprising:
transmitting a repetition configuration associated with transmitting a plurality of repetitions of an uplink transmission, the repetition configuration including at least one of:
offset information indicating an offset between a first repetition of the plurality of repetitions and a second repetition of the plurality of repetitions,
starting symbol information indicating a starting symbol of the first repetition and a starting symbol of the second repetition, or
size information indicating a size of the first repetition and a size of the second repetition; and
receiving at least one repetition of the uplink transmission based at least in part on the repetition configuration.

11. The method of claim 10, wherein the offset information indicates a fixed offset associated with the plurality of repetitions.

12. The method of claim 10, wherein the offset information indicates a sequence of offsets, each offset in the sequence of offsets being associated with a different pair of repetitions from the plurality of repetitions.

13. The method of claim 10, wherein the offset between the first repetition and the second repetition is indicated in terms of symbols, sub-slots, or slots.

14. The method of claim 10, wherein the starting symbol information indicates a sequence of starting symbols, each starting symbol in the sequence of starting symbols being associated with a different repetition of the plurality of repetitions,
wherein a given starting symbol in the sequence of starting symbols is relative to a beginning of a slot containing a corresponding repetition of the plurality of repetitions.

15. The method of claim 10, wherein the starting symbol of the first repetition or the starting symbol of the second repetition is indicated in terms of a symbol, a sub-slot, or a slot.

16. The method of claim 10, wherein the size information indicates a sequence of sizes, each size in the sequence of sizes being associated with a different repetition from the plurality of repetitions.

17. The method of claim 10, wherein the uplink transmission is a physical uplink control channel (PUCCH) transmission or a physical uplink shared channel (PUSCH) transmission.

18. The method of claim 10, wherein the repetition configuration is transmitted via at least one of radio resource control (RRC) signaling, in a medium access control (MAC) control element, or in downlink control information (DCI).

19. A user equipment (UE) for wireless communication, comprising:
a memory;
a transceiver; and
one or more processors, coupled to the transceiver and the memory, configured to:
receive, via the transceiver, a repetition configuration associated with transmitting a plurality of repetitions of an uplink transmission, the repetition configuration including at least one of:
offset information indicating an offset between a first repetition of the plurality of repetitions and a second repetition of the plurality of repetitions, start symbol information indicating a starting symbol of the first repetition and a starting symbol of the second repetition, or
size information indicating a size of the first repetition and a size of the second repetition; and
transmit, via the transceiver, at least one repetition of the uplink transmission based at least in part on the repetition configuration.

20. The UE of claim 19, wherein the offset information indicates a fixed offset associated with the plurality of repetitions.

21. The UE of claim 19, wherein the offset information indicates a sequence of offsets, each offset in the sequence of offsets being associated with a different pair of repetitions from the plurality of repetitions.

22. The UE of claim 19, wherein the offset between the first repetition and the second repetition is indicated in terms of symbols, sub-slots, or slots.

23. The UE of claim 19, wherein the starting symbol information indicates a sequence of starting symbols, each starting symbol in the sequence of starting symbols being associated with a different repetition of the plurality of repetitions,
wherein a given starting symbol in the sequence of starting symbols is relative to a beginning of a slot containing a corresponding repetition of the plurality of repetitions.

24. The UE of claim 19, wherein the starting symbol of the first repetition or the starting symbol of the second repetition is indicated in terms of a symbol, a sub-slot, or a slot.

25. The UE of claim 19, wherein the size information indicates a sequence of sizes, each size in the sequence of sizes being associated with a different repetition from the plurality of repetitions.

26. A base station for wireless communication, comprising:
a memory;
a transceiver; and
one or more processors, coupled to the transceiver and the memory, configured to:
transmit, via the transceiver, a repetition configuration associated with transmitting a plurality of repetitions of an uplink transmission, the repetition configuration including at least one of:
offset information indicating an offset between a first repetition of the plurality of repetitions and a second repetition of the plurality of repetitions, start symbol information indicating a starting symbol of the first repetition and a starting symbol of the second repetition, or
size information indicating a size of the first repetition and a size of the second repetition; and
receive, via the transceiver, at least one repetition of the uplink transmission based at least in part on the repetition configuration.

27. The base station of claim 26, wherein the offset information indicates at least one of:
a fixed offset associated with the plurality of repetitions, or
a sequence of offsets, each offset in the sequence of offsets being associated with a different pair of repetitions from the plurality of repetitions.

28. The base station of claim 26, wherein the starting symbol information indicates a sequence of starting symbols, each starting symbol in the sequence of starting symbols being associated with a different repetition of the plurality of repetitions,
wherein a given starting symbol in the sequence of starting symbols is relative to a beginning of a slot containing a corresponding repetition of the plurality of repetitions.

29. The base station of claim 26, wherein the repetition configuration is transmitted via at least one of radio resource control (RRC) signaling, in a medium access control (MAC) control element, or in downlink control information (DCI).

30. The base station of claim 26, wherein the size information indicates a sequence of sizes, each size in the sequence of sizes being associated with a different repetition from the plurality of repetitions.
